(19) United States
(12) Patent Application Publication
(10) Pub. No.: US 2007/0125153 A1
(43) Pub. Date: Jun. 7, 2007

(54) Palladium-Nickel Hydrogen Sensor

(76) Inventors: Thomas Visel, Austin, TX (US); Prabhu Soundarrajan, Austin, TX (US); Igor Pavlovsky, Cedar Park, TX (US)

Correspondence Address: FISH & RICHARDSON P.C., P.O BOX 1022, Minneapolis, MN, 55440-1022, US

(21) Appl. No.: 11/551,630

(22) Filed: Oct. 20, 2006

Related U.S. Application Data
(60) Provisional application No. 60/728,980, filed on Oct. 21, 2005.

(51) Int. Cl. B82B 1/00; G01N 27/00

(52) U.S. Cl. 73/31.05; 977/957; 422/94

(57) ABSTRACT

A device for sensing hydrogen utilizes a palladium-nickel alloy of nanoparticles deposited on a substrate between two electrodes connected to an electrical circuit. As hydrogen is sensed the resistance of the device changes, which can then be measured and monitored.

This application claims priority to U.S. Provisional Application Ser. No. 60/728,980 and PCT/US2006/030314.

### TECHNICAL FIELD

This invention relates to sensing of hydrogen, and more particularly to a hydrogen sensor using nanoparticles.

### BACKGROUND

PCT Application No. PCT/US2006/030314 discloses a sensor for hydrogen composed of nanoparticles of palladium or palladium alloy. In that disclosure, the alloy is palladium-silver (Pd—Ag), in a ratio of 60:40. The sensors are capable of operation down to the few ppm level, although they may be constructed for operation in either high or low concentrations of hydrogen.

### DESCRIPTION OF DRAWINGS

FIG. 1 illustrates growth of a palladium particle;

FIG. 2 illustrates an active sensor element;

FIG. 3 illustrates an embodiment of the present invention;

FIG. 4 illustrates an embodiment of the present invention mounted on a carrier board;

FIG. 5 illustrates standard reduction potentials;

FIG. 6 illustrates growth of nickel versus palladium over time;

FIGS. 7-10 illustrate samples of sensor elements;

FIGS. 11-18 illustrate FTIR measurements and comparisons to other chemical compositions.

Like reference symbols in the various drawings indicate like elements.

### DETAILED DESCRIPTION

Embodiments of the present invention use nickel in place of silver as the alloy with palladium for hydrogen sensors. In a 60:40 Pd—Ni ratio, it may solve a number of issues relevant to silver.

Some advantages in use of Pd—Ni are:

1. Pd—Ni produces hydrogen sensors that are approximately 3-4× faster than silver alloy sensors.

2. Pd—Ni sensors may be just as sensitive as Pd—Ag sensors, when the nickel is accounted for in the plating process. Because of the different electromotive distance from both Pd and Ag, a Pd-Ni alloy requires a longer plating time than a Pd-Ag alloy to develop equivalent particle size-density ratios to those of a Pd—Ag alloy.

3. The Pd—Ni sensor may be more robust in the face of surface blocking agents. For example, in Pd—Ag, sulfur in oil appears to enable the bonding of long hydrocarbon chains to the surface of the Pd—Ag particles via an Ag—S bond. This creates the effect of a one-way check valve, allowing hydrogen to diffuse out of the particles, but making it a difficult and slow process for new hydrogen to diffuse into the particles. A dissociation rate of hydrogen molecules into mono-atomic hydrogen at the contaminated palladium surface becomes slow, although the later hydrogen recombination rate is not affected as much. This slows down the Pd—Ag sensor response on subsequent runs, particularly in hot oil. By contrast, the Pd—Ni alloy may not accumulate either sulfur or hydrocarbon chains, with the result that they maintain their response speeds.

4. The overall repeatability of the Pd—Ni may be better than Pd—Ag alloy. This may be due to the presumed graduated reduction in Ni concentration towards the edges of the particles, as noted in #5, below. The nickel alloy may not become as fatigued by the diffusion (‘breathing’) of hydrogen in and out of the alloy, and changes to the crystal lattice, with the subsequent growth/shrink cycles, as the silver alloy does.

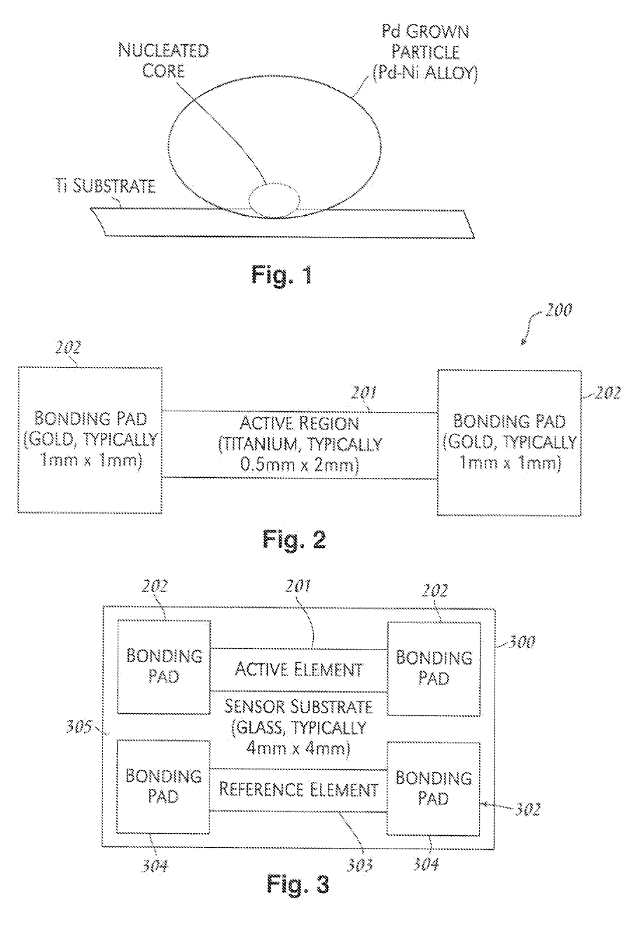

5. With nickel, more control in the plating process may be achieved because its electro-potential value is significantly different than palladium. The result is a sensor with greater immunity to hydrogen loading shock damage. During the course of the plating process, as the surface potential starts to approach that of nickel's potential, plating of nickel diminishes in relation to palladium. Referring to FIG. 1, the result is that the alloy near the surface may have a higher concentration of Pd in it, with a graded increase in nickel percentage.

There are other alloys which yield similar properties to nickel, due to their position on the electromotive gamut. They can be an alternative to either nickel or silver as an alloy with palladium.

Referring to FIG. 2a, sensor 200 may be constructed in a manner similar as done in PCT/US2006/030314, which is incorporated by reference herein. The hydrogen sensors comprise a substrate upon which the sensor 200 is formed. While various materials as silicon or glass may be used, borosilicate glass may be used because of its closer thermal matching with palladium. This is a factor in operation at extended temperatures.

The active element 201 comprises a thin layer of resistive material, such as titanium metal. While this relative reactive metal has its down-sides, it is of value here because of electro-chemical properties. A rectangular area of this metal, for example, 0.5×2.0 mm, is deposited on the substrate. At each end, contact pads 202 of gold are evaporated on, all by photo-lithographic techniques. While the sizes of the elements are not critical to the invention, they happen to be convenient and produce devices of the proper overall resistance range desired.

Onto the active region 201 is plated a set of palladium alloy nanoparticles. By varying plating conditions, these nanoparticles may be varied in size from nominally 70 nm or larger, to nominally 30 nm or smaller.

Plating is a two-step process in which the first phase applies a voltage or current to the element, using a potentiometric plating method. By varying the nucleation voltage or current, and time, the particle density may be determined, for example, in nominal particles per square micron.

The second step of the process continues the plating growth, but at a very low current and for a longer time period. The requisite plating growth time is generally much long. These matters are described in more detail below.

In operation, a constant current is placed across the bonding pad connections 202, typically of 20 micro-amps. The voltage drop is then measured, from which resistance can be computed. Upon exposure to hydrogen, the nano-particles grow in size, shorting out the resistive titanium gaps between adjacent particles. In this manner, hydrogen exposure results in a reduction of effective resistance between the two bonding pad electrodes 202.

As noted earlier, titanium is a relatively reactive metal, particularly with oxygen. During exposure to oxygen, particularly at high temperatures, the surface of the Ti is permanently oxidized, reducing the effective thickness of the Ti, and increasing the apparent resistance between the terminals. If not accounted for, this would be observed as a drift in the sensor, with both time and temperature.

To offset this effect, two things must be done:

1. The sensor is subjected to oxygen at elevated temperatures for a specified period, 12 hours at 100° C., for example. This forms a thick oxide through which additional oxygen at operational temperatures has difficulty penetrating. This passivation process greatly stabilizes the long-term operation of the sensor.

2. Referring to FIG. 3, because there will yet be a finite (though small) continuation of the oxidation process, a second ‘dummy’ sensor element 302 is incorporated into the sensor 300. It contains the same area and thickness of titanium, but has no palladium particles plated on it. The almost-identical drift of (reference) element 303 is used to compensate the active element 201 for changes of resistance with time and temperature.

This reference element 303 is alongside the active element 201 on the same substrate 305, and formed at the same time and under the same conditions as the active element 201. Therefore, for each sensor 300, two elements are present, one active 201 and one reference 303.

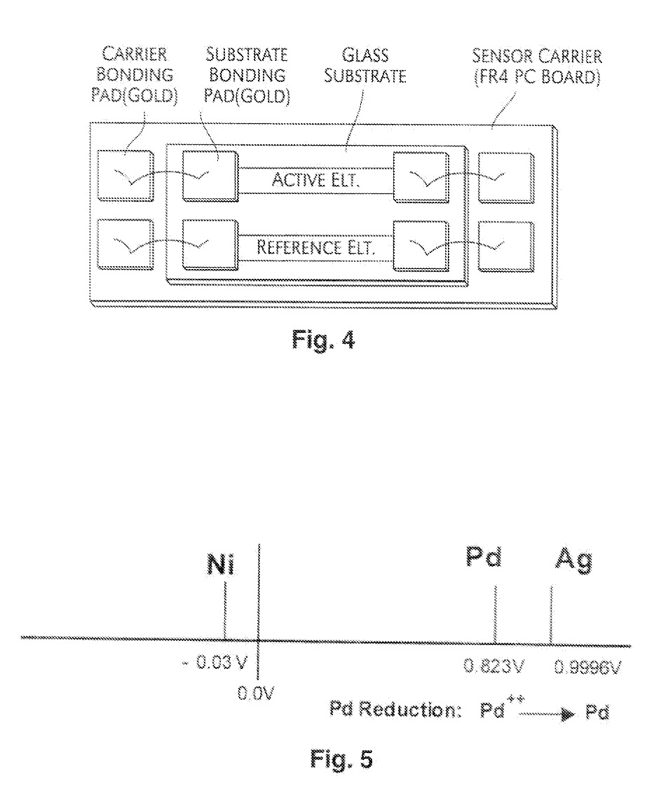

Referring to FIG. 4, sensors 300 may be packaged for mechanical convenience on a larger carrier surface. It may be convenient to use 0.031″ FR-4 printed circuit board for this purpose. The sensor is die-bonded to the board, and the gold bond pads of the sensor are wire-bonded to suitable bond pads on the carrier board. The wire-bonds are then encapsulated using a commercial 2-part epoxy for the purpose, such as from Epotek. This is standard chip-on-board technique.

The packaged sensor 300 is conditioned using oxygen and hydrogen, in separate steps. It is first placed in a pure-oxygen environment at an elevated temperature for 12 hours at 100° C., for example, to oxidize the elements. This aging greatly retards future drift of the sensor.

The sensor 300 is then placed in a pure-hydrogen environment at elevated temperatures for several hours at 100° C. It is then allowed to cool slowly back to room temperature over a period of several hours. This initial infusion of hydrogen stabilizes the sensor 300 for future exposure to hydrogen. The model used to describe this is a ‘pre-distortion’ of certain lattice-edge regions of the palladium, causing small amounts of entrapment of hydrogen in them.

The palladium atomic lattice opening for hydrogen is about 1.1 times the size of atomic hydrogen. Any disruption of the lattice, such as by lattice edge and alloy-induced faults, could disturb this rather optimal size ratio. When the lattice grows (up to 5%) by introduction of either hydrogen or heat, these edge effects could permanently entrap hydrogen, permanently changing its baseline resistance. By conditioning in hydrogen, these changes are out of the way, prior to calibration.

The sensors are then calibrated by placing them in a known concentration of hydrogen, either in oil or in gas as appropriate, and stepping the temperatures across the desired range of operation. At each step, the element resistances are recorded. The hydrogen concentration is reduced, e.g., by a factor of two or ten, for oil or for air, and the temperature step-and-measure process is repeated. In this manner, a 2-D curve set is built up of resistances versus temperature and hydrogen. A computer interpolates from such a calibration curve set to derive the actual hydrogen currently present.

On the surface, there is no obvious reason why the active region should comprise a solid palladium/alloy region or that the region be striped. Thorough investigation of this matter clearly indicates that stripes, e.g., 10 micron stripes and 10 micron spaces appear to be an optimal configuration. Factors considered include repeatability, speed of operation, and other issues.

Further, it has been found that for reason of E-field effects, that a 20-micron unplated guard band exists around the active region. Without such a guard band, plating would result in a continuous film, rather than in particles, along such high E-field areas such as the sensor edges and ends.

The Pd—Ni alloys are plated from a similar solution bath as the Pd-Ag alloys with one exception that a nickel salt replaces a silver salt in their composition. It should be noted that the nanoparticle alloy morphology is a little different than Pd—Ag alloy and hence are the electrochemical plating conditions. The Pd-Ni alloys are plated onto a titanium substrate from a Pd-Ni alloy solution using a higher nucleation (−100 microamperes for 9 seconds) and growth currents (−4 microamperes for ˜480 seconds) for plating in comparison to the Pd—Ag alloys. The Pd—Ni film does not show any problems of de-lamination as the Pd—Ag films did at the same conditions providing more control over the plating process.

The electrochemical reduction potentials for Pd=0.9996V, Ag=0.823V, Ni=−0.03V (all Vs Ag/AgCl) are shown in FIG. 5. In the chronoamperometry experiments, the metal is reduced from the solution phase as long as the potential is negative of the standard reduction potential. In a typical plating experiment, the potential crosses 0V in the first 60 seconds of the growth period. The nickel reduction from solution is stopped after the 60 second period, but the palladium is still deposited on the substrate till the end of the plating process. This results in a core of Pd—Ni and a shell of Pd metal in a nanoparticle.

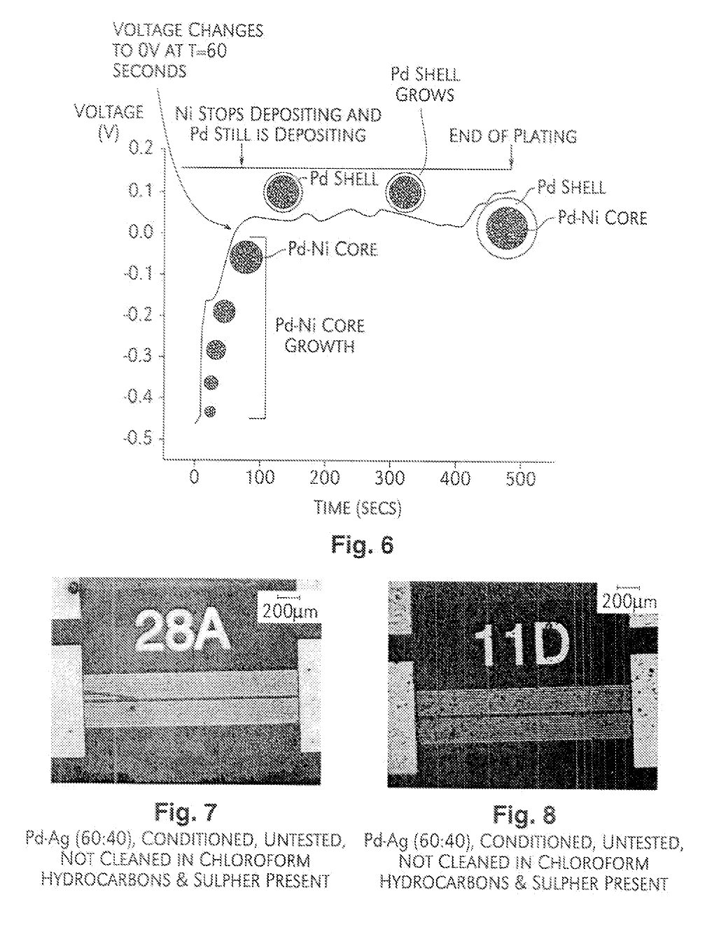

Because of the large separation in FIG. 5 of the Ni potential from the Pd and Ag potentials, the growth rate of nickel slows and finally stops as the plating interface voltage rises above zero volts. FIG. 6 shows the plating of palladium continuing on, such that the final particles have a Pd—Ni core and a Pd exterior. SIMS studies confirm the absence of nickel on the surface.

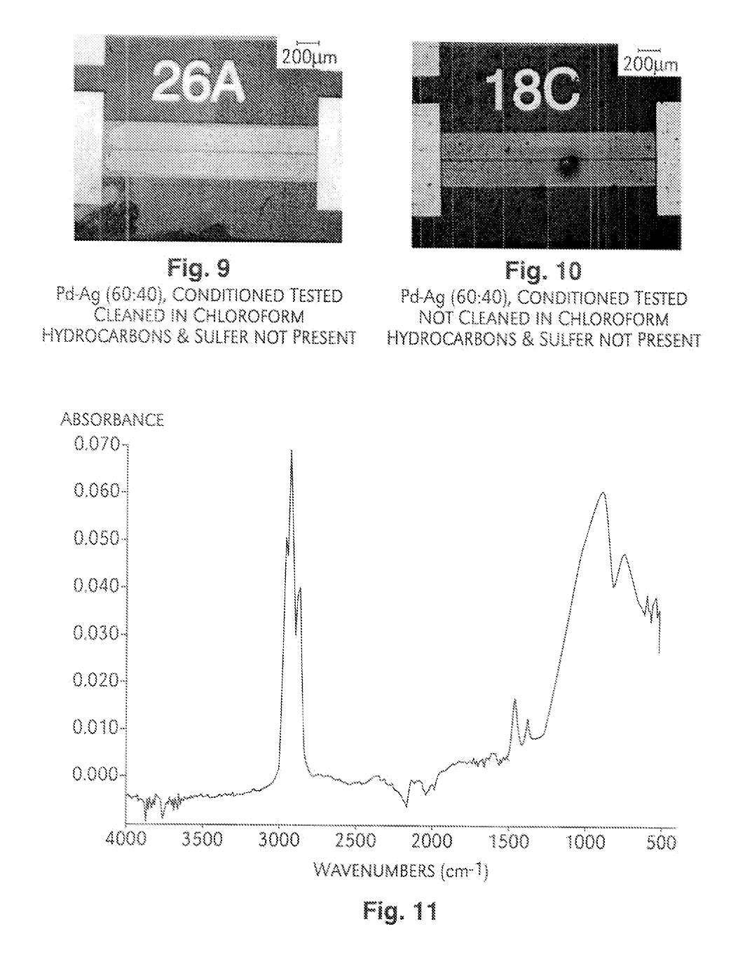

A FTIR (Fourier Transform InfraRed spectroscopy analysis) on hydrogen sensor was performed to understand the surface blockage and contamination. Four samples were tested as shown in FIGS. 7-10. These are optical micrographs of samples 727-28A, 676-11D, 672-26A and 713-18C with their conditions and their results from FTIR.

The following images illustrate test results to confirm the impact of sulfur and hydrocarbons.

FIG. 11 shows FTIR results for sample 727-28A. Peaks are seen at 3000 cm⁻¹ (corresponds to C—H bonds), 1000 cm⁻¹ (corresponds to S—O bonds) and 1500 cm⁻¹ (correspond to C—C bonds).

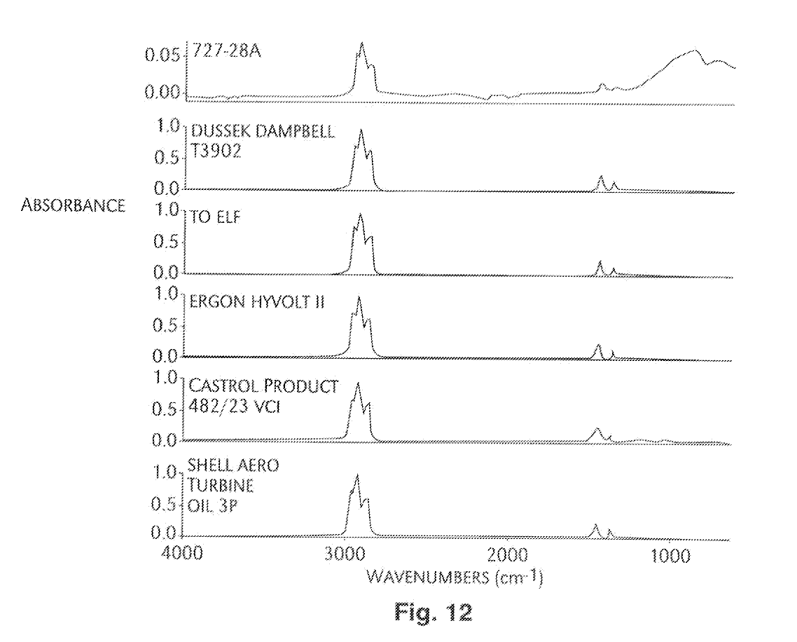

Comparison with literature reveals that the closest match is DUSSEK CAMPBELL T3902 an insulating oil for transformers, as shown in FIG. 12.

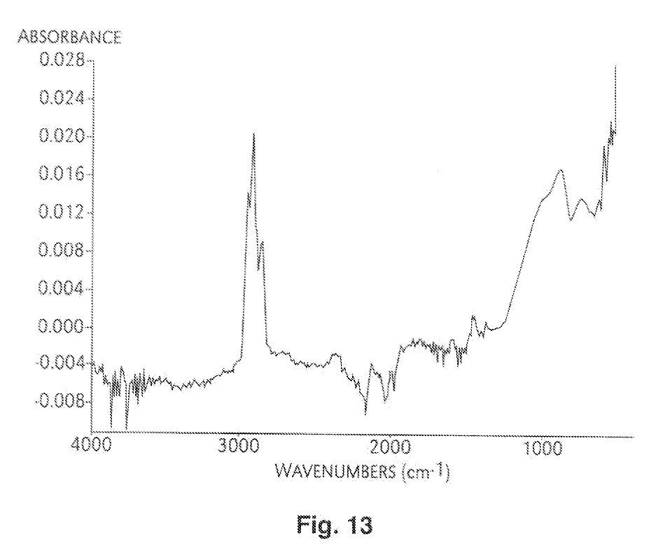

FTIR results for sample 676-11D are shown in FIG. 13. Peaks are seen at 3000 cm⁻¹ (corresponds to C—H bonds), 1000 cm⁻¹ (corresponds to S—O bonds) and 1500 cm⁻(corresponds to C—C bonds).

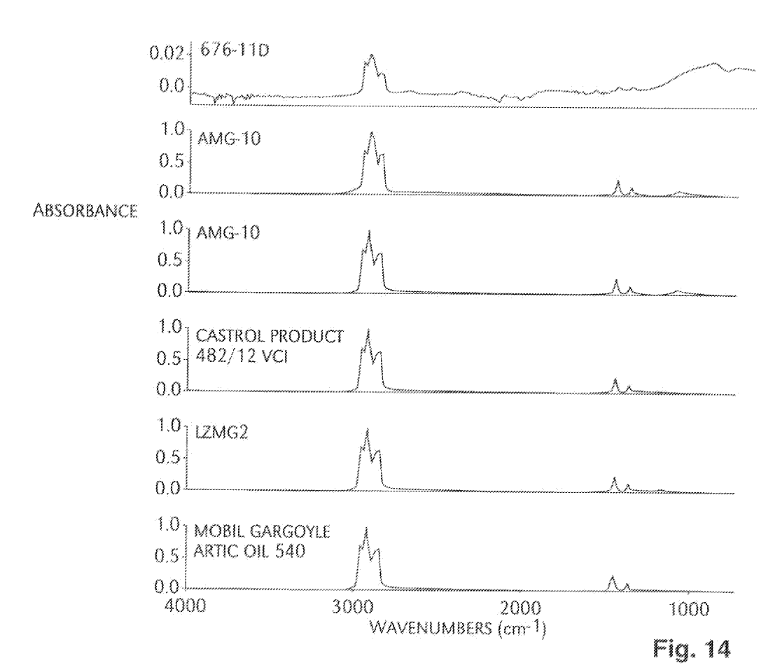

Comparison with literature reveals that the closest match is AMG10 a hydraulic oil, having long chain hydrocarbons (C₁₅ to C₃₀). This is shown in FIG. 14.

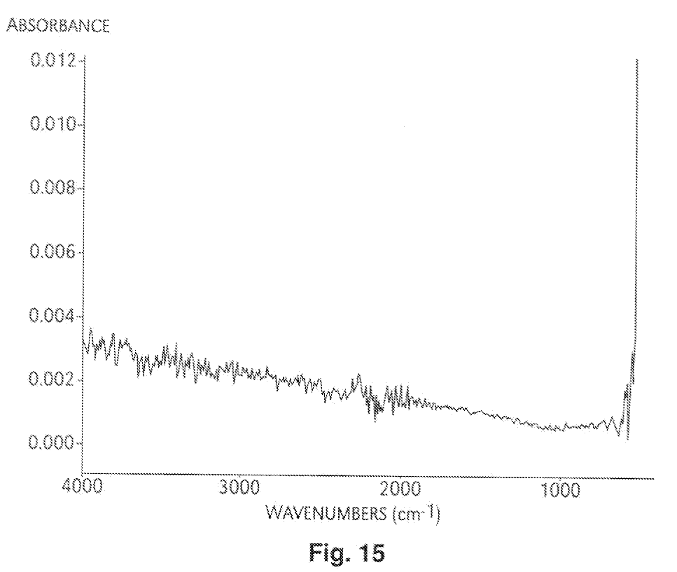

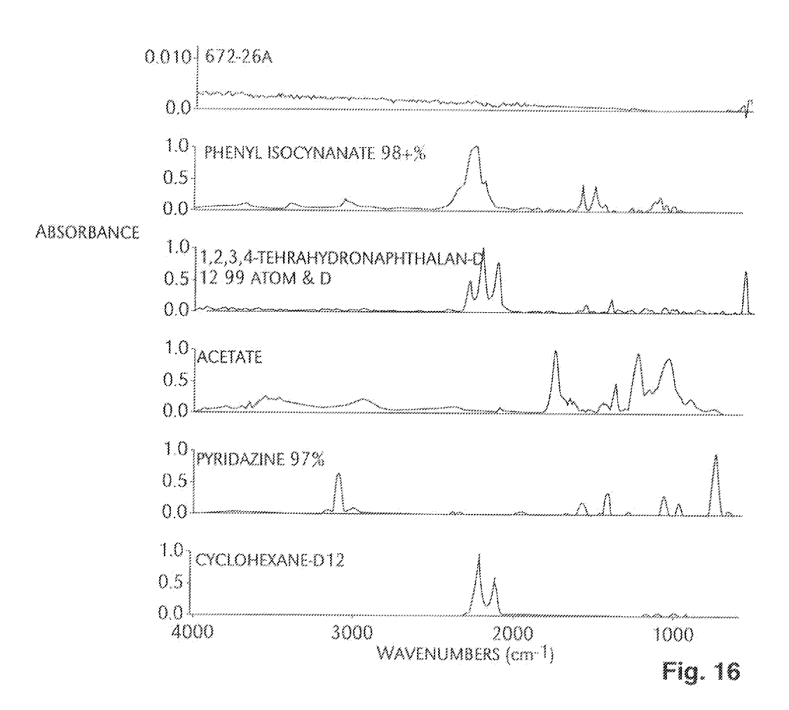

FTIR results for sample 672-26A are given in FIG. 15. No peaks are seen indicating the presence of C—H or S—O bonds are seen revealing that the chloroform cleaned the hydrocarbon and sulphur contamination on the surface. No chlorine or alcohols were present (see FIG. 16).

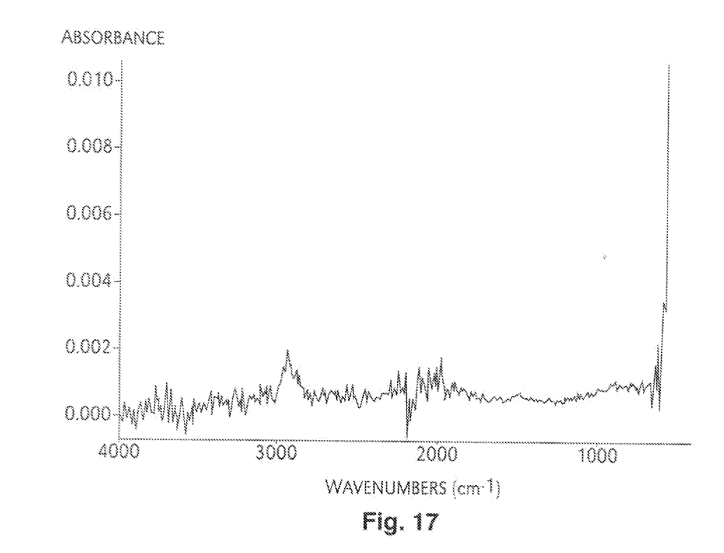

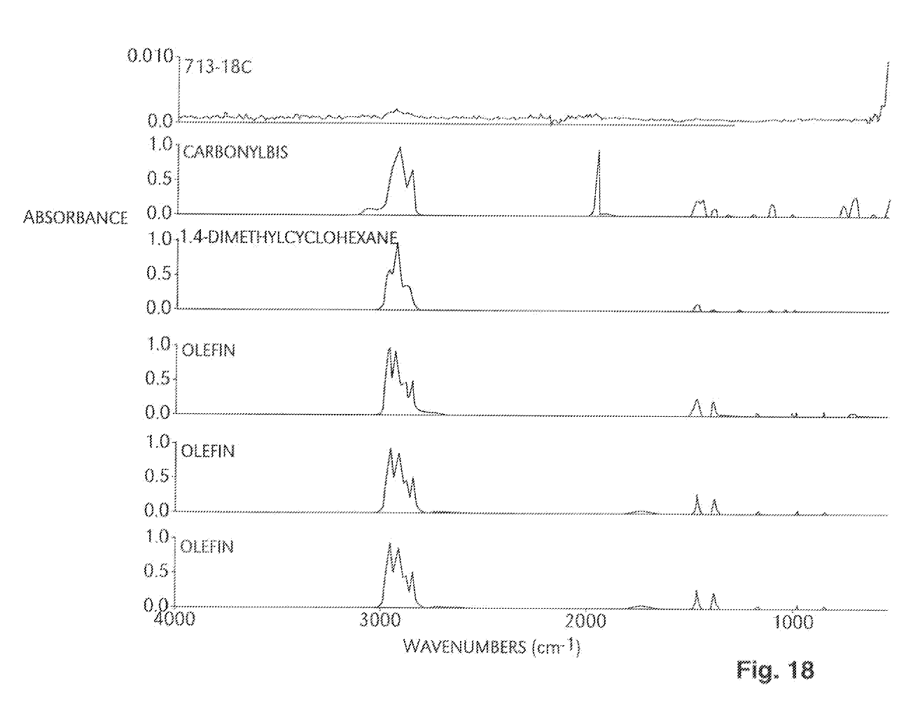

FTIR results for sample 713-18C (Pd—Ni) are shown in FIG. 17. No peaks are seen indicating the presence of C—H or S—O bonds are seen revealing Pd—Ni has not been contaminated by sulphur or hydrocarbons in oil. (See also representative oils in FIG. 18).

1. FTIR results indicate that the Pd—Ag alloy sensors have sulphur and long chain hydrocarbons on the surface.

2. Chloroform cleaned the hydrocarbon and sulphur contamination on the surface.

3. Pd—Ni sensor has not been contaminated by sulphur or hydrocarbons in oil.

What is claimed is:

1. A hydrogen sensor device based on palladium-nickel nanoparticles.
